(19) United States
(12) Patent Application Publication
(10) Pub. No.: US 2026/0307292 A1
(43) Pub. Date: Oct. 8, 2026

(54) ADDITIVE MANUFACTURING OF SURFACES WITH ANTI-CORROSION AND/OR ANTI-FOULING CHARACTERISTICS

(71) Applicant: Chevron U.S.A. Inc., San Ramon, CA (US)

(72) Inventors: Benjamin M. Chaloner-Gill, Alameda, CA (US); Robert Ernest Rettew, Houston, TX (US)

(21) Appl. No.: 19/576,710

(22) Filed: Mar. 24, 2026

Related U.S. Application Data
(60) Provisional application No. 63/783,035, filed on Apr. 3, 2025.

(51) Int. Cl. B28B 1/00; B22F 10/28; B33Y 10/00

(52) U.S. Cl. CPC B28B 1/001; B22F 10/28; B33Y 10/00; B22F 2998/10

(57) ABSTRACT

A method of forming equipment using an additive manufacturing process includes: forming, by the additive manufacturing process, a base portion of the equipment; changing one or more settings of at least one laser used in the additive manufacturing process; and forming, by the additive manufacturing process after changing the one or more settings of the laser, a surface on an outside of the base portion of the equipment, the surface being microtextured, nanotextured, or a combination thereof.

### CROSS-REFERENCE TO RELATED APPLICATION

This application claims priority to and the benefit of U.S. Provisional Patent Application No. 63/783,035 titled “Additive Manufacturing of Surfaces with Anti-Corrosion and/or Anti-Fouling Characteristics” and filed on Apr. 3, 2025, the entire contents of which are incorporated herein by reference.

### FIELD OF THE INVENTION

The present disclosure is directed generally to manufacturing textured surfaces and, more particularly, to using additive manufacturing to form textured surface with anti-corrosion and/or anti-fouling characteristics.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Corrosion and/or fouling of equipment can have undesired impacts in a variety of industrial applications. Corrosion involves the degradation and/or removal of material from surfaces, while fouling involves the deposition and/or buildup of an outside material on surfaces. Equipment that may be subject to undesired corrosion and/or fouling can include, for example, heat transfer equipment, subsea equipment, equipment in water cooling towers, submersible pumps, and control valves, among others. It is becoming increasingly common to apply special coatings to equipment surfaces in attempts to minimize the impact or occurrence of corrosion and/or fouling of such equipment. For example, nanotexturing of equipment surfaces through a wet chemical process, electrolytics, and/or etching can improve anti-fouling characteristics of said surfaces. Such preparation of equipment coatings, however, are typically expensive and can require special handling.

It is now recognized that a need exists for inexpensive methods of manufacturing equipment surfaces with improved anti-corrosion and/or anti-fouling characteristics.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with aspects of the disclosure, a method of forming equipment using an additive manufacturing process includes: forming, by the additive manufacturing process, a base portion of the equipment; changing one or more settings of at least one laser used in the additive manufacturing process; and forming, by the additive manufacturing process after changing the one or more settings of the laser, a surface on an outside of the base portion of the equipment, the surface being microtextured, nanotextured, or a combination thereof.

### BRIEF DESCRIPTION OF DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 is a cross-sectional view of an example equipment part having a microtextured and/or nanotextured surface formed by additive manufacturing, in accordance with one or more aspects of the present disclosure.

FIG. 2 is a process flow diagram illustrating a method of manufacturing equipment using an additive manufacturing process, in accordance with one or more aspects of the present disclosure.

FIG. 3 is a process flow diagram illustrating another method of manufacturing equipment using an additive manufacturing process, in accordance with one or more aspects of the present disclosure.

FIG. 4 is a process flow diagram illustrating another method of manufacturing equipment using an additive manufacturing process, in accordance with one or more aspects of the present disclosure.

### DETAILED DESCRIPTION OF THE INVENTION

The present disclosure is directed to methods using additive manufacturing to generate equipment with textured surfaces that provide anti-corrosion characteristics, anti-fouling characteristics, or both to the equipment. In some embodiments, the textured surface(s) may include a microtextured surface, meaning a surface having structural features or patterns on the surface with dimensions in the micrometer range (e.g., between 0.1 and 100 micrometers). In some embodiments, the textured surface(s) may include a nanotextured surface, meaning a surface having structural features or patterns on the surface with dimensions in the nanometer range (e.g., between 1 and 100 nanometers). In some embodiments, the textured surface may be both microtextured and nanotextured at different locations on the surface.

Additive manufacturing (e.g., using a 3-D printer) can allow for a large amount of freedom for creation of structural features and surface aspects of various sizes. The disclosed methods of using additive manufacturing to form a microtextured and/or nanotextured surface, rather than using a separate coating or chemical surface treatment, provides improved flexibility in terms of what structural features or aspects can be applied to the surface. For example, it may be desirable to tailor the surface of the equipment being formed via additive manufacturing to provide a surface that is hydrophobic, hydrophilic, oleophobic, oleophilic, or a combination thereof, with different designs and different aspects. The disclosed methods of manufacturing an equipment part through additive manufacturing can change the surface energy of the part, giving it properties that prevent, reduce, minimize, or delay the onset of deposition of certain compounds (such as water, oil, scale, etc.) on the surface. The disclosed additive manufacturing process may use a plurality of different metals or metallurgies to build the desired surface texture and/or surface profile. One or more materials used in the additive manufacturing process to form the surface may later be reacted with one or more other chemicals to provide a surface treatment to the additive manufactured surface. The disclosed methods using additive manufacturing may produce any desired pattern and/or surface texture on an equipment surface to provide anti-corrosion and/or anti-fouling characteristics to the part.

The phrase “anti-corrosion and/or anti-fouling characteristics” used throughout this disclosure refers to one or more anti-corrosion characteristics, one or more anti-fouling characteristics, or a combination of one or more anti-corrosion characteristics and one or more anti-fouling characteristics. The terms “properties” and “attributes” are used similarly as the term “characteristics.” As such, the phrase “anti-corrosion and/or anti-fouling properties” used throughout this disclosure refers to one or more anti-corrosion properties, one or more anti-fouling properties, or a combination of one or more anti-corrosion properties and one or more anti-fouling properties. Similarly, the phrase “anti-corrosion and/or anti-fouling attributes” used in this disclosure refers to one or more anti-corrosion attributes, one or more anti-fouling attributes, or a combination of one or more anti-corrosion attributes and one or more anti-fouling attributes. The phrase “anti-corrosion and/or anti-fouling surface” used in this disclosure refers to a surface having one or more anti-corrosion characteristics (or properties or attributes), one or more anti-fouling characteristics (or properties or attributes), or a combination of one or more anti-corrosion characteristics (or properties or attributes) and one or more anti-fouling characteristics (or properties or attributes).

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The disclosed methods using additive manufacturing to form equipment surfaces with certain anti-corrosion and/or anti-fouling characteristics is different in multiple ways from traditional additive manufacturing techniques. First, the disclosed methods utilize additive manufacturing to prepare a textured surface, rather than trying to optimize the smoothest surface possible. Typical additive manufacturing processes use a 3-D printer having a laser that is used to melt metal powder into a solid, with the aim to provide the smoothest outer surface possible. In the event the resulting outer surface does have a rougher texture, the additive manufactured part is then machined down to provide a smooth outer surface.

The disclosed methods of manufacturing equipment with anti-fouling and/or anti-corrosion characteristics does not include any post-machining step to smooth the outer surface(s). Rather, the additive manufacturing process purposely generates an outer surface with a desired texture to achieve the anti-corrosion and/or anti-fouling properties. To provide the microtextured and/or nanotextured surface needed for the anti-corrosion and/or anti-fouling properties, one or more settings of the laser being used in the additive manufacturing process would be manipulated from its normal operational settings. The settings of the laser to be adjusted may include laser power, heat input, and/or spot size of the laser, among others. The result of the changed laser setting(s) may include the following: a lower strength material is printed; the printer may not focus the laser beam the same way; the printer may not melt the metal powder the same way. With the changed laser settings, the 3-D printer performing the additive manufacturing may intentionally print the part with a rougher surface (in particular, with a microtextured surface and/or a nanotextured surface) than is currently possible under its normal operational settings. The laser setting(s) may be changed back and forth between its original factory settings and the new settings for textured surfaces at different times throughout printing the equipment with the textured surface(s). For example, the 3-D printer may be operated using its original laser settings while printing an inner base portion of the part, and changed to operating with new laser settings to print the textured surface over the base portion.

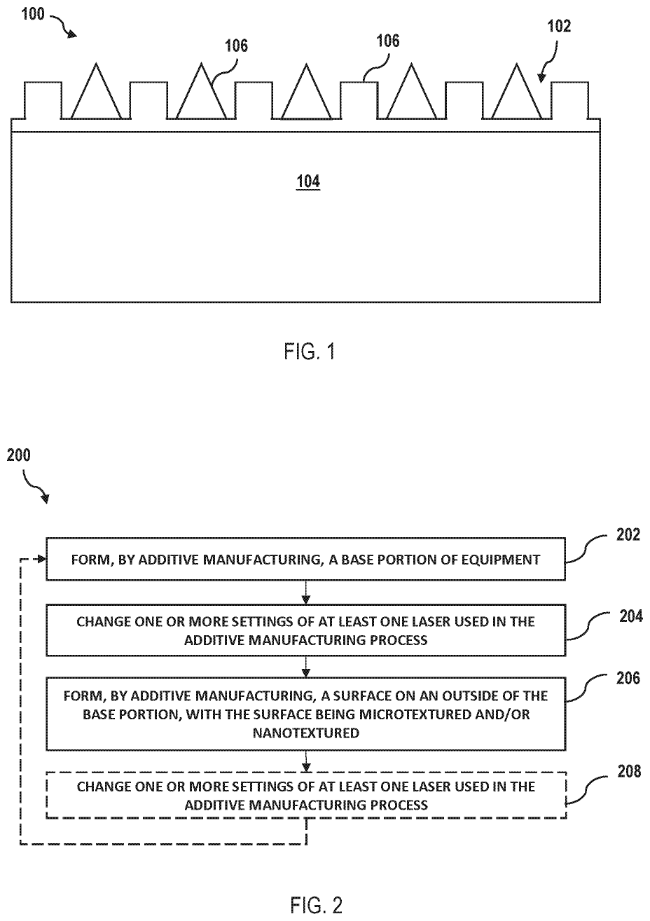

FIG. 1 is a side cross-sectional view of an example part 100 having an additive manufactured surface 102 formed thereon through an additive manufacturing process as disclosed herein. It should be noted that FIG. 1 only shows one portion of the part 100 having one textured surface 102 formed using additive manufacturing. As shown, the part 100 includes an inner base portion 104 beneath the surface 102. The base portion 104 may be formed by additive manufacturing with different laser settings, as described above, or through other manufacturing techniques. The part 100 may have additional surfaces (not shown in FIG. 1) that are formed using additive manufacturing to provide anti-corrosion and/or anti-fouling characteristics. It will be understood that the illustrated part 100 and corresponding textured surface 102 of FIG. 1 are not drawn to scale.

As shown, the surface 102 may be formed (using additive manufacturing) with a textured or coarse outer surface, rather than a smooth surface. For example, the surface 102 may include multiple protrusions 106 pointing in an outward direction away from the base portion 104. The surface profile may also include gaps or channels formed between the protrusions 106. The protrusions 106 may have any desired shape. For example, in FIG. 1, some protrusions 106 are rod-shaped while others are cone-shaped. Other shapes and relative sizes of protrusions may be used in other embodiments. As illustrated, the surface 102 may include different types, shapes, and/or sizes of protrusions 106 formed on the same surface 102. In other embodiments, the protrusions 106 on the surface 102 may be uniform. The protrusions may be arranged in any desired pattern on the surface 102. For example, in FIG. 1, the rod-shaped protrusions and cone-shaped protrusions are alternating. Other embodiments may have different patterns of protrusions and channels. Although the textured surface pattern is visible only along one dimension of the surface 102 in FIG. 1, the pattern may extend along a second dimension of the surface 102 as well. In embodiments where the surface 102 is three-dimensional rather than planar, the pattern may extend along the surface 102 in three dimensions.

In some embodiments, the surface 102 may be formed from a single material via additive manufacturing. In other embodiments, the surface 102 may include a combination of different metals layered in a particular manner through the additive manufacturing process. For example, as shown in FIG. 1, the surface 102 may include parts that are constructed from a first metallic material (e.g., the rod-shaped protrusions) and parts that are constructed from a second metallic material (e.g., the cone-shaped protrusions) different from the first material.

The microtextured and/or nanotextured pattern may be provided via additive manufacturing around an entire outside of the part in some embodiments. In other embodiments, the microtextured and/or nanotextured pattern may be provided via additive manufacturing along just one or more specific portion(s) of the part 100 that are expected to be exposed to corrosive or fouling materials, while other outside surfaces of the part 100 do not have the texturing. In this way, the additive manufacturing process for constructing the part 100 provides flexibility in terms of the number and arrangement of surface(s) of the part 100 that are microtextured and/or nanotextured for anti-corrosion purposes, anti-fouling purposes, or both.

It should be noted that FIG. 1 is exemplary and any desired pattern of one or more metals can be formed via additive manufacturing to create the microtextured and/or nanotextured surface on equipment without departing from the scope of the present disclosure.

The additive manufacturing processes described herein may be used to generate many different types of equipment used in a variety of contexts without departing from the scope of the present disclosure. For example, the additive manufacturing process may be used to add an anti-corrosion and/or anti-fouling surface to a heat transfer component, a wellhead component, an electric submersible pump (ESP) component, a valve, a power connector for subsea equipment, a hydraulic connector for subsea equipment, a mechanical actuator for subsea equipment, as well as other equipment. In the context of heat transfer equipment, the microtextured and/or nanotextured surface formed using additive manufacturing may reduce, prevent, minimize, or delay the onset of fouling in the form of soft deposits such as hydrocarbons on the equipment. In the context of subsea and/or wellhead equipment, the microtextured and/or nanotextured surface formed using additive manufacturing may reduce, prevent, minimize, or delay the onset of fouling in the form of hard deposits such as calcium on the equipment. In the context of ESP components, the microtextured and/or nanotextured surface formed using additive manufacturing may reduce, prevent, minimize, or delay the onset of fouling in the form of hard deposits such as sulfate, phosphate, or carbonate buildup on the equipment. The additive manufacturing processes disclosed herein may be used on equipment formed for use in the oil and gas industry, the power sector, and/or any number of industries that use control valves. The particular additive manufacturing process used to form a microtextured and/or nanotextured surface may be different for equipment used in different service environments.

FIG. 2 is a process flow diagram illustrating a method 200 of forming equipment using an additive manufacturing process in accordance with the present disclosure. It should be noted that the method 200 shown in FIG. 2 is an example and other embodiments may include additional steps not shown, have one or more illustrated steps removed, or have certain illustrated steps performed in different orders than shown, without departing from the scope of the present disclosure.

At block 202, the method 200 includes forming, by an additive manufacturing process (e.g., using a 3-D printer), a base portion of the equipment. At block 204, the method 200 includes changing one or more settings of at least one laser (of the 3-D printer) used in the additive manufacturing process. The setting(s) may include, for example, laser power, heat input, and/or spot size of the laser. The setting(s) may be changed from a set of original laser settings to a set of surface-specific laser settings. At block 206, the method 200 may include, after changing the one or more settings of the laser, forming by additive manufacturing (e.g., using the 3-D printer) a surface on an outside of the base portion of the equipment. The surface formed on the outside of the base portion is microtextured, nanotextured, or both.

In some embodiments, the method 200 may include the steps of blocks 202-206 each performed once to form the equipment. For example, the method 200 may include: forming the entirety of the base portion of the equipment using the additive manufacturing process (block 202) before changing the one or more settings of the at least one laser (block 204), and then forming the entirety of the surface (block 206) on the outside of the base portion of the equipment only after changing the one or more settings of the at least one laser (block 204).

In other embodiments, as shown at block 208, the method 200 may include changing one or more settings of the at least one laser (of the 3-D printer) used in the additive manufacturing process once again. The setting(s) may be changed from the set of surface-specific laser settings back to the set of original laser settings, or to another set of laser settings. After this, steps 202-206 of the method 200 may be repeated. As such, the method 200 may include switching back and forth between forming parts of the base portion of the equipment and forming parts of the surface on an outside of the base portion, thus 3-D printing the equipment and its textured coating in multiple layers. The method 200 may include changing the one or more settings of the at least one laser from a set of original settings to a set of surface-specific settings and back again, and then repeating this switching of the one or more settings multiple times throughout the formation of the base portion and the surface.

Once the equipment is formed via the additive manufacturing processes, there may be no post-machining step to smooth out the surface. Instead, the surface remains textured to provide the desired anti-corrosion and/or anti-fouling characteristics.

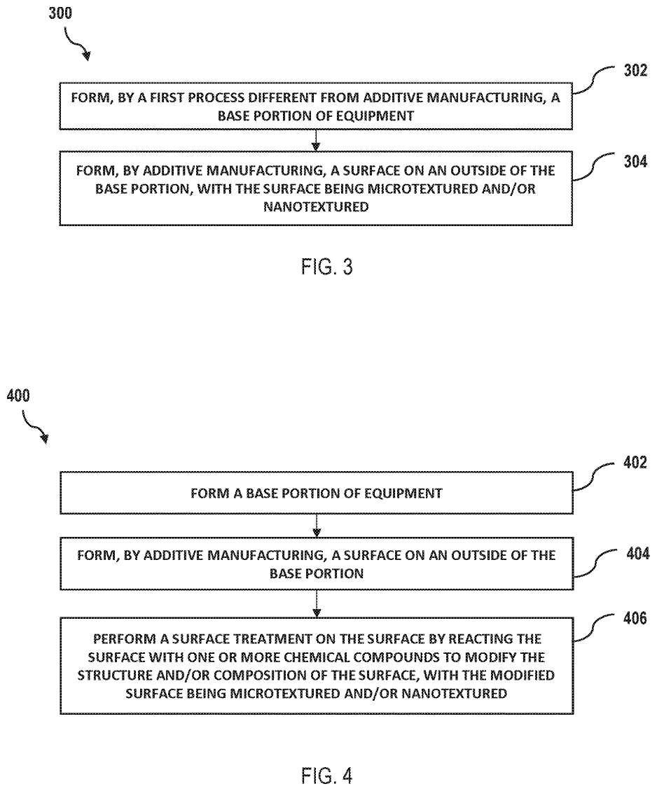

FIG. 3 is a process flow diagram illustrating a method 300 of forming equipment using an additive manufacturing process in accordance with the present disclosure. It should be noted that the method 300 shown in FIG. 3 is an example and other embodiments may include additional steps not shown, have one or more illustrated steps removed, or have certain illustrated steps performed in different orders than shown, without departing from the scope of the present disclosure.

At block 302, the method 300 includes forming, by a first process different from additive manufacturing, a base portion of the equipment. At block 304, the method 300 includes forming, by an additive manufacturing process, a surface on an outside of the base portion of the equipment. The surface formed on the outside of the base portion is microtextured, nanotextured, or both. As such, the method 300 may include taking a part that was previously machined in some other way and then using 3-D printing to add the textured surface to provide whatever anti-corrosion and/or anti-fouling attributes are desired. The base portion formed in step 302 may be formed of a first material, while the surface formed in step 304 may be formed of at least one other material different from the first material.

Once the surface is formed on the outside of the base portion via the additive manufacturing process, there may be no post-machining step to smooth out the surface. Instead, the surface remains textured to provide the desired anti-corrosion and/or anti-fouling characteristics.

FIG. 4 is a process flow diagram illustrating a method 400 of forming equipment using an additive manufacturing process in accordance with the present disclosure. It should be noted that the method 400 shown in FIG. 4 is an example and other embodiments may include additional steps not shown, have one or more illustrated steps removed, or have certain illustrated steps performed in different orders than shown, without departing from the scope of the present disclosure.

At block 402, the method 400 includes forming a base portion of the equipment. This may be accomplished as described above with reference to the steps 202/302 of methods 200/300 shown in FIG. 2/3. At block 404, the method 400 includes forming, by an additive manufacturing process, a surface on an outside of the base portion of the equipment. At block 406, the method 400 includes performing a surface treatment on the surface by reacting the surface with one or more chemical compounds to modify the structure and/or the composition of the surface. The modified surface resulting from the surface treatment of step 406 is microtextured, nanotextured, or a combination thereof. In some embodiments, the surface treatment of block 406 may cause the modified surface of the equipment to be hydrophobic, hydrophilic, oleophobic, oleophilic, or a combination thereof. In some embodiments, the surface formed at block 404 by the additive manufacturing process may comprise a metal oxide or a metal hydroxide. As such, the method 400 may include taking a part, using 3-D printing to add a textured surface to the outside of the part to provide whatever anti-corrosion and/or anti-fouling attributes are desired, and reacting the outside of the part with another chemical compound to enhance the anti-corrosion and/or anti-fouling attributes of the part.

Once the surface is formed on the outside of the base portion via the additive manufacturing process and the surface treatment is performed (block 406), there may be no post-machining step to smooth out the modified surface. Instead, the modified surface remains textured to provide the desired anti-corrosion and/or anti-fouling characteristics.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A method of forming equipment using an additive manufacturing process, the method comprising:
forming, by the additive manufacturing process, a base portion of the equipment;
changing one or more settings of at least one laser used in the additive manufacturing process; and
forming, by the additive manufacturing process after changing the one or more settings of the laser, a surface on an outside of the base portion of the equipment, the surface being microtextured, nanotextured, or a combination thereof.

2. The method of claim 1, further comprising changing the one or more settings of the at least one laser from a set of original settings to a set of surface-specific settings and back, and repeating this switching of the one or more settings multiple times throughout the formation of the base portion and the surface.

3. The method of claim 1, further comprising:
forming the entirety of the base portion of the equipment using the additive manufacturing process before changing the one or more settings of the at least one laser; and
forming the entirety of the surface on the outside of the base portion of the equipment after changing the one or more settings of the at least one laser.

4. The method of claim 1, wherein the equipment comprises a heat transfer component, a wellhead component, an electric submersible pump (ESP) component, a valve, a power connector for subsea equipment, a hydraulic connector for subsea equipment, or a mechanical actuator for subsea equipment.

5. A method of forming equipment using an additive manufacturing process, the method comprising:
forming, by a first process different from additive manufacturing, a base portion of the equipment; and
forming, by the additive manufacturing process, a surface on an outside of the base portion of the equipment, the surface being microtextured, nanotextured, or a combination thereof.

6. The method of claim 5, wherein the base portion is formed of a first material during the first process, and wherein the surface is formed of a second material different from the first material during the additive manufacturing process.

7. The method of claim 5, wherein the equipment comprises a heat transfer component, a wellhead component, an electric submersible pump (ESP) component, a valve, a power connector for subsea equipment, a hydraulic connector for subsea equipment, or a mechanical actuator for subsea equipment.

8. A method of forming equipment using an additive manufacturing process, the method comprising:
forming a base portion of the equipment;
forming, by the additive manufacturing process, a surface on an outside of the base portion of the equipment; and
performing a surface treatment on the surface by reacting the surface with one or more chemical compounds to modify the structure and/or the composition of the surface, wherein the modified surface resulting from the surface treatment is microtextured, nanotextured, or a combination thereof.

9. The method of claim 8, wherein the surface treatment causes the modified surface to be hydrophobic, hydrophilic, oleophobic, oleophilic, or a combination thereof.

10. The method of claim 8, wherein the surface formed by the additive manufacturing process comprises a metal oxide.
